(19) United States
(12) Patent Application Publication
(10) Pub. No.: US 2022/0112392 A1
(43) Pub. Date: Apr. 14, 2022

(54) SPRAYABLE CONDUCTIVE INK AND CONDUCTIVE DEVICE

(71) Applicant: TPK Touch Solutions (Xiamen) Inc., Xiamen (CN)

(72) Inventors: Lung Pin Chen, Chiayi City (TW); Xue Fen Wang, Taoyuan City (TW); Chun Hung Chu, Hsinchu City (TW); Wei Chou Chen, Taoyuan City (TW)

(21) Appl. No.: 17/065,596

(22) Filed: Oct. 8, 2020

(51) Int. Cl. C09D 11/52; H01B 1/22; H05B 3/46; H05B 1/02

(52) U.S. Cl. CPC C09D 11/52; H01B 1/22; C08K 3/08; H05B 1/0291; H05B 3/46

(57) ABSTRACT

A sprayable conductive ink includes 0.05 to 1 part by weight of a metal nanowire, 0.1 to 1 part by weight of a resin, 97.9 to 99.5 parts by weight of a solvent, and 0.02 to 0.1 parts by weight of an additive, in which the conductive ink is used for spraying on a substrate.

### BACKGROUND

### Field of Disclosure

The present disclosure relates to an ink, and more particularly relates to a sprayable conductive ink.

### Description of Related Art

Various ink coating methods have been developed with the advancement of technology, such as a slot die coating. The slot die coating can be a continuous roll to roll process or a sheet to sheet process. However, the traditional slot die coating can only be used for the coating of flat substrates, and it is not easy to use for dealing with three-dimensional (3D) curved substrates.

Another ink coating method is a spray coating. The spray coating can solve the problem with the traditional slot die coating, that is difficult to deal with 3D curved substrates. However, after spraying an ink on a substrate and then baking the substrate to volatilize the solvent and other substances, it is easy to cause the layer of ink to have uneven and defective appearances, such as bubbles, pinholes, cloudy mura, and pitch mura.

In view of the above, there is an urgent need to develop a new ink to overcome the aforementioned problems.

### SUMMARY

In order to solve the above problems and overcome the shortcomings of the prior art, the purpose of the present disclosure is to provide a sprayable metal nanowire ink, so the transparent metal conductive layer formed by the ink has good appearances and optical properties.

The present disclosure provides a sprayable conductive ink. The sprayable conductive ink includes 0.05 to 1 part by weight of a metal nanowire, 0.1 to 1 part by weight of a resin, 97.9 to 99.5 parts by weight of a solvent, and 0.02 to 0.1 parts by weight of an additive, in which the sprayable conductive ink is used for spraying on a substrate.

In some embodiments, the sprayable conductive ink has a viscosity between 0.5 cP and 50 cP.

In some embodiments, the sprayable conductive ink has a surface tension between 10 mN/m and 50 mN/m.

In some embodiments, a material of the metal nanowire is copper, gold, silver, nickel, iron, tin, or palladium.

In some embodiments, the resin is polyvinyl butyral resin, ethyl cellulose, polyethylene, polystyrene, polytetrafluoroethylene, phenolic resin, polyamide resin, polypropylene, polycarbonate, hydroxypropyl methylcellulose, methylcellulose, carboxymethyl cellulose, or organosilicon.

In some embodiments, the additive is selected from a group consisting of octylphenol ethoxylate, nonylphenol ethoxylate alkylphenol, fluorinated surfactant, modified polysiloxane, and a copolymer of organosilicon and glycol

In some embodiments, the additive includes a surfactant, a dispersant, a surface adjuster, a defoaming agent, or a combination thereof.

In some embodiments, the sprayable conductive ink includes 0.001 to 0.01 parts by weight of the surfactant.

In some embodiments, the sprayable conductive ink includes 0.01 to 0.1 parts by weight of the dispersant.

In some embodiments, the sprayable conductive ink includes 0.01 to 0.1 parts by weight of the surface adjuster.

In some embodiments, the sprayable conductive ink includes 0.02 to 0.1 parts by weight of the defoaming agent.

The present disclosure provides a conductive device. The conductive device includes a substrate and an ink layer. The substrate is covered by the ink layer, in which the ink layer is formed by spraying the sprayable conductive ink. A resistance of the ink layer is between 18 and 22 Ohm/square, a transmittance of the ink layer is greater than 90%, and a haze of the ink layer is less than 1.8%.

In some embodiments, the ink layer can be connected to an external power source to heat the conductive device.

In some embodiments, the external power source provides a predetermined power density so that the conductive device rises by more than 20° C. in a predetermined period.

In some embodiments, the ink layer has a smooth surface under a strong light.

In some embodiments, a resistance ratio of the ink layer is 0.97±0.09 in two orthogonal directions.

In some embodiments, the substrate is a curved substrate.

The above description will be described in detail by way of embodiments, and a further explanation will be provided for the technical solution of the present disclosure.

### BRIEF DESCRIPTION OF THE DRAWINGS

The patent or application file contains at least one drawing executed in color. Copies of this patent or patent application publication with color drawing(s) will be provided by Office upon request and payment of the necessary fee. The detailed description of the present disclosure will be fully understood when read with the accompanying drawings. It is noted that, in accordance with the standard practice in the industry, various features are not drawn to scale and are used for illustration purposes only. In fact, the size of each feature can be increased or decreased arbitrarily for the purpose of clarity.

FIG. 1A to FIG. 1D are experimental photographs of the metal conductive layers under a strong light according to some comparative examples of the present disclosure.

FIG. 2 illustrates a schematic view of spraying machine equipment according to some embodiments of the present disclosure.

FIG. 3 illustrates a cross-sectional view of a conductive glass according to some embodiments of the present disclosure.

FIG. 4 is an experimental photograph of a metal conductive layer under a strong light according to some embodiments of the present disclosure.

FIG. 5 illustrates a table including parameters of examples according to some embodiments of the present disclosure.

FIG. 6 illustrates a table including results of a heating rate experiment according to some embodiments of the present disclosure.

FIG. 7 illustrates a table including ink compositions according to some embodiments of the present disclosure.

### DETAILED DESCRIPTION

In the following, multiple embodiments of the present disclosure will be disclosed with the accompanying drawings. Many practical details will be described in the following description for clarity. However, it should be understood that these practical details should not be used to limit the present disclosure. That is, in some embodiments of the present disclosure, these practical details are unnecessary. In addition, in order to simplify the drawings, some conventionally used structures and elements will be shown in a simple schematic manner in the drawings.

In the embodiments and the scope of the patent application, unless the article is specifically limited in the context, “a” and “the” can generally refer to a single or plural. With regard to “about”, “around” or “approximately” used herein, the error or range of the value is generally within about 20%, preferably within about 10%, preferably within about 5%. In addition, in accordance with the present disclosure, the technical term “part(s) by weight” is used to express the content of the chemical composition. For example, if the overall parts by weight of the solution composition are 100 parts by weight, 50 parts by weight of composition A represent 50 wt % of composition A.

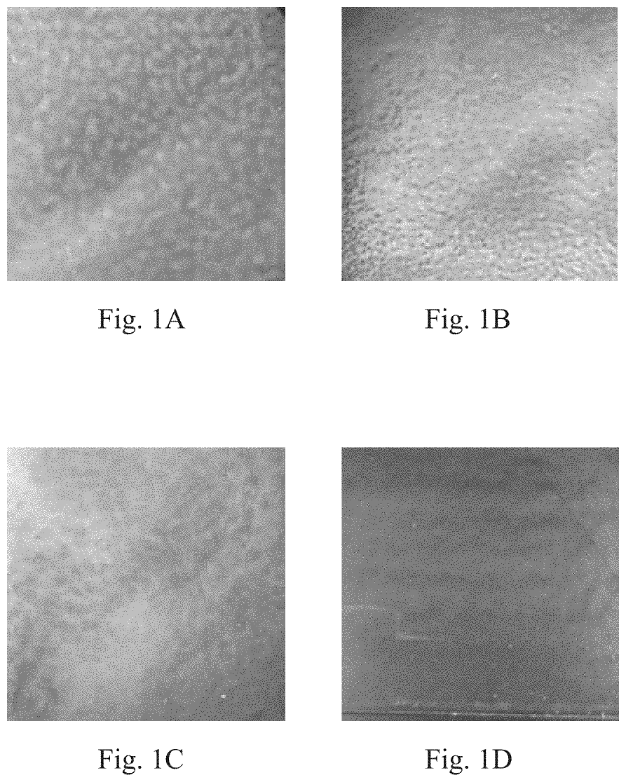

Although the spray coating can solve traditional slot die coating problems, such as being difficult to deal with 3D curved substrates, it is easy to cause the uneven and defective appearance of the ink layer after the ink is coated on the substrate by spraying. FIG. 1A to FIG. 1D are experimental photographs of metal conductive layers under a strong light according to some comparative examples of the present disclosure. As shown in FIG. 1A to FIG. 1D, the metal conductive layer in FIG. 1A has bubbles, the metal conductive layer in FIG. 1B has pinholes, the metal conductive layer in FIG. 10 has cloudy mura, and the metal conductive layer FIG. 1D has pitch mura under a strong light.

To solve the above problems, the present disclosure provides a sprayable conductive ink, inkjet, and/or slurry. The spray coating is used to atomize the ink of the present disclosure, so that the ink forms uniform and fine droplets, and then a wet ink layer is formed on the substrate. Next, the wet ink layer is baked to form a dry ink layer, thereby forming a transparent and conductive film (also called a transparent metal conductive layer) on the substrate. The spraying technique has the advantages of being simple process, using low equipment cost, being able to be coated on a non-flat substrate, reducing the amount of material, enabling automation, having high efficiency, and having a wide range of applicable materials. The materials used in the spraying technique can be, for example, metals, alloys, ceramics, and so on. The spraying technique of the present disclosure may include an air spraying or an electrostatic spraying, but the disclosure is not limited thereto. The sprayable conductive ink of the present disclosure has good inkjet properties and can be used for spraying various substrates, such as flat substrates, curved substrates, and non-flat surface substrates. The disclosure can also solve the problem of the traditional slot die coating, which cannot handle curved substrates well.

The substrate used in the present disclosure includes glass, wafer, quartz, polyethylene terephthalate (PET), cyclic olefin polymer (COP), cycloolefin copolymer (COC), polycarbonate (PC), polymethyl methacrylate (PMMA), polyimide (PI), polyethylene naphthalate (PEN), polyvinylidene fluoride (PVDF), or polydimethyl siloxane (PDMS), but the disclosure is not limited thereto. In one embodiment, the conductive ink of the present disclosure is sprayed on a glass substrate, and then the glass substrate is baked to form a dry ink layer, thereby forming a transparent and conductive glass. In another embodiment, the glass coated with the sprayable conductive ink of the present disclosure can be applied to, for example, automotive glasses (such as windshields or other glasses). Therefore, the conductive ink sprayed and formed in this embodiment has good optical properties (high transmittance, low haze, and good appearance) and appropriate heating properties. Generally speaking, the conductive ink sprayed in this embodiment has a resistance in a range from 18 to 22 Ohm/square, the transmittance is greater than 90% (to visible light having a wavelength in a range from 400 nm to 700 nm), and the haze is less than 1.8%. The heating properties are mainly applied for the defogging and/or defrosting of automotive glasses and other functions. If the conductive ink glass in this embodiment is assembled in a car, the conductive ink glass has excellent optical properties, and users would not see the conductive ink layer on the car window. This can solve the problem that metal electrodes set are as heating coils and block the traditional car window's sight line.

The sprayable conductive ink of the present disclosure includes a metal nanowire, a resin, a solvent, and a surfactant. In one embodiment, the surface tension of the sprayable conductive ink is between 10 mN/m and 50 mN/m. For example, the surface tension is, 10, 15, 20, 25, 30, 35, 40, 45, or 50 mN/m. In one embodiment, the surface tension of the sprayable conductive ink is between 20 mN/m and 30 mN/m. In another embodiment, the surface tension of the sprayable conductive ink is between 25 mN/m and 35 mN/m. It should be noted that the surface tension of the ink in the suitable range can yield a transparent conductive layer with better properties. If the surface tension of the ink is too large or too small, it will affect the process and spraying results, and then affect the appearance of the transparent metal conductive layer. When the surface tension is less than 10 mN/m, the ink may be excessively dispersed, thereby affecting the spraying process. When the surface tension is greater than 50 mN/m, it is not easy to effectively control the distribution of ink components, thereby affecting the overall properties of the ink layer.

In one embodiment, the viscosity of the sprayable conductive ink is between 0.5 cP and 50 cP. For example, the viscosity is 0.5, 1, 5, 10, 15, 20, 25, 30, 35, 40, 45, or 50 cP. It should be noted that the viscosity of the ink in this range can yield a transparent conductive layer with better properties. If the viscosity of the ink is too large or too small, it will affect the process and spraying results, thereby affecting the appearance of the transparent metal conductive layer. When the viscosity of the ink is less than 0.5 cP, the ink is easy to be too excessively dispersed, and the ink cannot be evenly sprayed on the substrate. When the viscosity of the ink is greater than 50 cP, the ink droplets tend to accumulate, thereby having the problem of nozzle clogging. Generally speaking, the spraying process and other ink coating methods, such as the slot die coating, are wet processes in which the ink is directly sprayed on the substrate and then cured. However, in consideration of the differences in the equipment and/or parameters, the viscosity of the sprayable conductive ink of this embodiment is about ⅓-⅕ of that of the nanometal wire ink applied in the slot die coating.

In one embodiment, in the sprayable conductive ink of the present disclosure, the metal nanowire accounts for 0.05 to 1 part by weight, the resin accounts for 0.1 to 1 part by weight, the solvent accounts for 97.9 to 99.5 parts by weight, and the additive accounts for 0.02 to 0.1 parts by weight. In one embodiment, the sprayable conductive ink is used for spraying on the substrate.

In one embodiment, the metal nanowire may include copper (Cu), gold (Au), silver (Ag), nickel (Ni), iron (Fe), tin (Sn), palladium (Pd), or alloys thereof, but the disclosure is not limited thereto. Specifically, the metal nanowire includes gold nanowire, silver nanowire, nickel nanowire, iron nanowire, tin nanowire, palladium nanowire, or a combination thereof. As used herein, “metal nanowire” is a collective term that refers to a collection of metal wires including multiple element metals, metal alloys, or metal compounds (including metal oxides), and the number of metal nanowire contained therein does not affect the scope of protection claimed in the present disclosure. At least one cross-sectional dimension (i.e., the diameter of the cross-section) of a single metal nanowire is less than about 500 nm, preferably less than about 100 nm, and more preferably less than about 50 nm. The metal nanostructure called “wire” herein has a high aspect ratio, for example, between about 10 and 100,000. More specifically, the aspect ratio (the length:diameter of cross-section) of the metal nanowire can be greater than about 10, preferably greater than about 50, and more preferably greater than about 100. The metal nanowire can be any metal or alloys thereof, including (but not limited to) silver, gold, copper, nickel, and gold-plated silver. Other terms, such as silk, fiber, tube, and so on, if they have the same dimension and high aspect ratio as mentioned above, are also covered by the present disclosure.

In one embodiment, the sprayable conductive ink includes 0.05 to 1 part by weight of the metal nanowire. When the metal nanowire of the ink is within the aforementioned range, the ink layer has both conductive and light-transmitting properties. When the composition of the nanowire of the ink is less than 0.05 parts by weight, the transparent metal conductive layer formed by the spraying process has poor conductive properties, which affect the conductivity. When the composition of the nanowire of the ink is greater than 1 part by weight, the transparent metal conductive layer formed by the spraying process has a bad transmittance.

In one embodiment, the resin may include polyvinyl butyral resin, ethyl cellulose, polyethylene, polystyrene, polytetrafluoroethylene, phenolic resin, polyamide resin, polypropylene, polycarbonic ester, hydroxypropyl methylcellulose, methylcellulose, carboxymethyl cellulose, organosilicon, or a combination thereof, but the disclosure is not limited thereto. In one embodiment, the sprayable conductive ink includes 0.1 to 1 part by weight of the resin. When the resin of the ink is within the aforementioned range, the resin can provide the suitable viscosity. For example, when the resin composition is less than 0.1 parts by weight, the adhesion of the ink is small and cannot be aggregated. When the resin composition of the ink is greater than 1 part by weight, it would cause the ink to be too viscous, unable to spray smoothly, and unable to achieve the uniform ink layer.

In one embodiment, the solvent may include water, methanol, ethanol, n-hexane, ethyl acetate, acetone, N,N-dimethyl formamide, acetic acid, n-butanol, n-propanol, isopropanol, N-methyl pyrrolidone, dimethyl formamide, dimethyl sulfoxide, hexamethyl phosphoramide, 1,3-dimethyl-2-imidazolinone, turpentine, turpentine oil, methyl acetate, formic acid or a combination thereof, but the disclosure is not limited thereto. In one embodiment, the sprayable conductive ink includes 97.9 to 99.5 parts by weight of the solvent. When the solvent of the ink is within the aforementioned range, the solvent in the ink can provide the ink with suitable fluidity, transferability, and uniformity.

In one embodiment, the additive includes a surfactant, a dispersant, a surface adjuster, a defoaming agent, or a combination thereof.

In one embodiment, the surfactant may include octylphenol ethoxylate, nonylphenol ethoxylate alkylphenol, fluorinated surfactant (FS-3100), modified polysiloxane (SL-1), polydimethylsiloxane (SL-8), a copolymer of organosilicon and glycol (SL-10W), or a combination thereof, but the disclosure is not limited thereto. In one embodiment, the sprayable conductive ink includes 0.02 to 0.1 parts by weight of the surfactant. When the surfactant of the ink is within the aforementioned range, the ink can maintain a suitable surface tension, so that the dispersion in the ink composition maintains stability. For example, when the surfactant of the ink is less than 0.02 parts by weight, excessive aggregates or precipitates may be generated. When the surfactant of the ink is greater than 0.1 parts by weight, there may be no aggregation effect between dispersoids. In one embodiment, the surfactant includes a fluorinated surfactant. The sprayable conductive ink includes 0.001 to 0.01 parts by weight of the surfactant. In one embodiment, the wet ink layer after spraying includes 0.0001 to 0.01 parts by weight of the surfactant. In one embodiment, the dry ink layer after baking includes 0.01 to 0.1 parts by weight of the surfactant.

In one embodiment, the dispersant may include a phosphate compound (DP-1), a mixture of polymer carboxylic acid and modified polysiloxane (DP-3SL), poly(ammonium acrylate) (DP-6W), Sodium polyacrylate [Anionic] (DP-2512W), acid group-containing polymer (DP-2140), polyurethane polymer (SDP), modified poly(methyl acrylate) copolymer (Disperbyk-2000), or a combination thereof, but the disclosure is not limited thereto. In one embodiment, the sprayable conductive ink further includes 0.02 to 0.1 parts by weight of the dispersant. When the dispersant of the ink is within the aforementioned range, the dispersant can ensure that the sprayable conductive ink will not aggregate, settle, or block the nozzle during the spraying process. For example, when the content of the dispersant of the ink is less than 0.02 parts by weight, the ink aggregation and sedimentation may not be avoided. When the dispersant of the ink is greater than 0.1 parts by weight, it may cause the ink to reside on the nozzle during spraying. In one embodiment, the sprayable conductive ink may include 0.01 to 0.1 parts by weight of the dispersant.

In one embodiment, the surface adjuster may include polymethyl alkyl siloxane solution (BYK-077), polyether-modified polymethyl alkyl siloxane solution (BYK-320), polyether-modified polydimethyl siloxane (BYK-331), epoxy functional methoxysilane (A8), phosphate compound (A10), or a combination thereof, but the disclosure is not limited thereto. In one embodiment, the sprayable conductive ink further includes 0.02 to 0.1 parts by weight of the surface adjuster. The surface adjuster can solve the problems of roughness and uneven surfaces, thereby forming a fine and dense film. In one embodiment, the sprayable conductive ink further includes 0.01 to 0.1 parts by weight of the surface adjuster.

In one embodiment, the defoaming agent may include organosilicon (BYK-023), mineral oil (BYK-034), hydrophobic particles (BYK-034), polyether siloxane copolymer (SDK-1), polyether silicone copolymer (SDK-4AF), polydimethyl siloxane (SDK-4350), or a combination thereof, but the disclosure is not limited thereto. In one embodiment, the sprayable conductive ink further includes 0.02 to 0.1 parts by weight of the defoaming agent. When the defoaming agent of the ink is within the aforementioned range, no foam will be generated during spraying. For example, when the content of the defoaming agent of the ink is less than 0.02 parts by weight, the ink will generate foam due to the alkaline substance in the composition, thereby affecting the appearance of the transparent metal conductive layer. When the content of the defoaming agent of the ink is greater than 0.1 parts by weight, it may affect the viscosity and surface tension of the ink, thereby affecting the overall properties of the ink and the transparent metal conductive layer. In one embodiment, the sprayable conductive ink further includes 0.01 to 0.1 parts by weight of the defoaming agent. Based on the ink composition of this embodiment, the heating effect of the coated transparent metal conductive layer formed by the spraying process is shown in the following embodiments.

The equipment of the spraying process includes a pressure tank, an electronic balance, a control panel, high-efficiency particulate air (HEPA), a spray room, a stage, a spray gun, an exhaust pipe, and a spraying machine equipment.

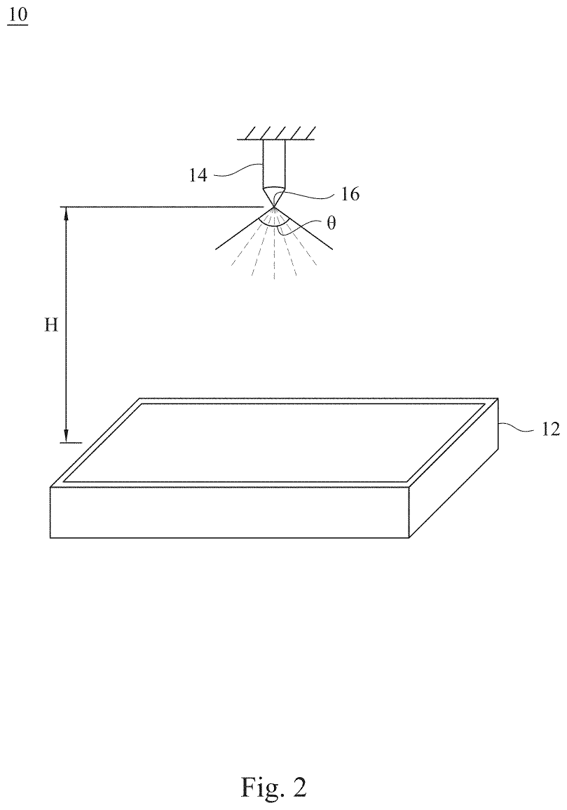

Please refer to FIG. 2, which is a schematic view of spraying machine equipment according to some embodiments of the present disclosure. The spraying machine equipment 10 includes a working stage 12 and a spray gun 14. The spray gun 14 is fixed above the working stage 12, and the vertical distance between the working stage 12 and the spray gun 14 is a spraying height H, as shown in FIG. 2. The spray gun 14 has a nozzle 16, and the nozzle 16 includes a nozzle angle θ. The nozzle angle θ can control the angle at which the ink is ejected. The spraying machine equipment 10 uses air pressure to lift up an ejector pin, so that the ink flows into the nozzle 16, and then the ink is atomized by atomizing pressure. The atomized ink is sprayed on a substrate, and the ink will be evenly dispersed on a substrate surface to form a wet ink layer. Then, the wet ink layer sprayed on the substrate is baked. A solvent and other substances in the wet ink layer are volatilized through a baking step to obtain an ink layer, that is, a transparent metal conductive layer. Parameters of the spraying machine equipment include a spraying speed, the spraying height H, an atomization pressure, the number of times the spraying is repeated, a spraying flow, the nozzle angle θ, a spraying pitch, a baking temperature, and a baking time.

In one embodiment, the spraying speed is between 100 and 1000 m/sec. In one embodiment, the spray height is between 2 and 100 mm. In one embodiment, the atomization pressure is between 0.5 and 5 psi. In one embodiment, the number of times the spraying is repeated is between 1 and 10. In one embodiment, the spraying flow is between 0.1 and 10 g/mm. In one embodiment, the nozzle angle is between 0 and 45 degrees. In one embodiment, the spraying pitch is between 0.5 and 10 mm. In one embodiment, the baking temperature is between 50 and 200° C. In one embodiment, the baking time is 1 to 60 minutes.

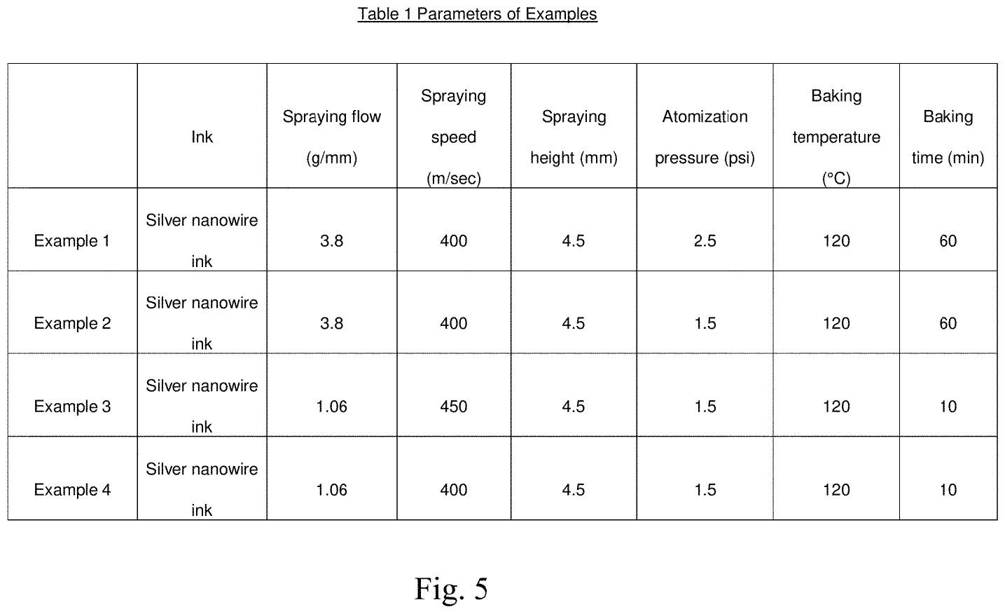

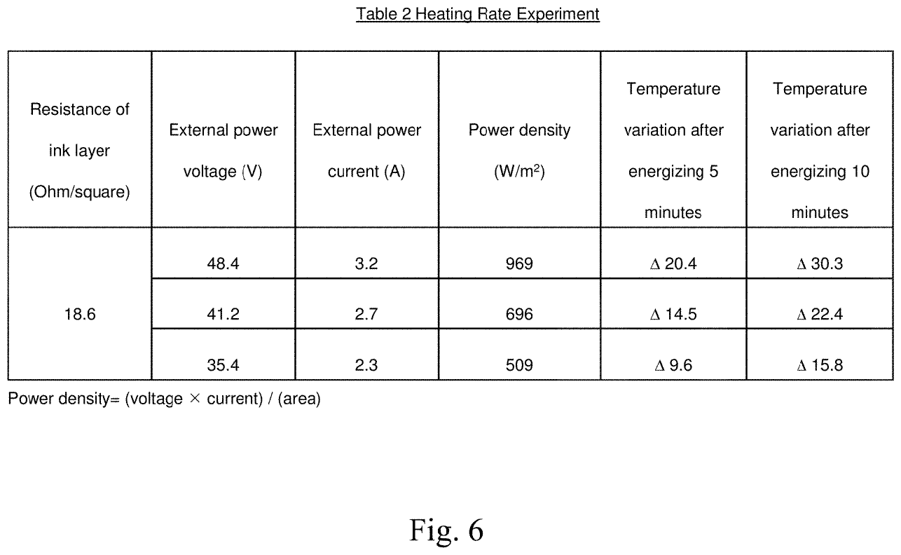

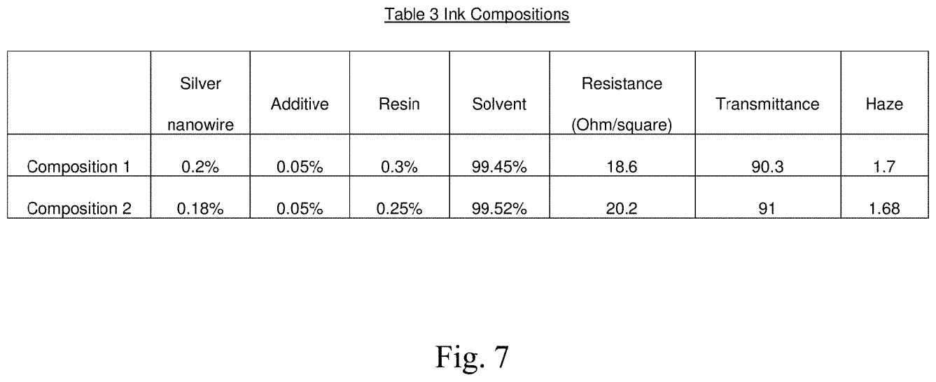

According to the spraying machine equipment, the above operations, and parameters of Examples in Tables 1 to 3, illustrated in FIGS. 5-7, the ink of the present disclosure was sprayed on a glass substrate measuring 370 mm×470 mm×1.8 mm (width×length×height), and then the glass substrate was baked to form a dry and transparent metal conductive layer. Next, a protective layer (also known as an overcoat, a top coat, a hardcoat, and so on, to indicate its function) was sprayed on the transparent metal conductive layer, and then the protective layer was baked. The material of the protective layer may be, for example, polyacrylate, epoxy resin, polyurethane, polysiloxane, polysiloxane, poly(silicon-acrylic), and so on. The finally obtained transparent metal conductive layer had a high transmittance, a low haze, and a good appearance, and there were no bad appearances such as bubbles, pinholes, cloudy mura, and pitch mura. When the resistance of the transparent metal conductive layer was between 18 and 22 Ohm/square, the transmittance of the transparent metal conductive layer was greater than 90%, and the haze was less than 1.8%. Composition 1 shown in Table 3 was used in Examples 1 to 4 shown in Table 1, and the results show that all the conductive films had the above-mentioned properties. Two different ink compositions, Compositions 1 and 2, are shown in Table 3. Table 3 shows the properties of the conductive film which were formed by spraying with Compositions 1 and 2 under the spraying conditions of Example 4 in Table 1.

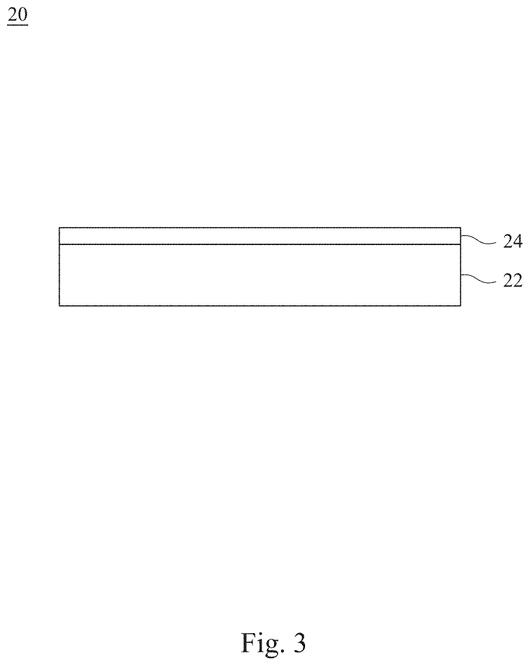

Please refer to FIG. 3, which illustrates a cross-sectional view of a conductive glass according to some embodiments of the present disclosure. A conductive glass 20 includes a glass 22 and an ink layer 24. The ink layer 24 is covered on the glass 22, in which the ink layer 24 is formed by spraying the sprayable conductive ink of the present disclosure. In one embodiment, the ink layer 24 may further include a protective layer. Because the metal nanowire in the ink layer 24 forms a net structure, the material of the protective layer can penetrate into the gaps between the metal nanowire to form a matrix material. Therefore, a composite conductive layer is formed by the conductive ink and the protective layer after the conductive ink is cured.

Because the spraying technique of this embodiment directly sprays the ink onto the substrate, the cured ink layer has fairly high isotropy. In other words, the properties of the ink layer in all directions, such as the electrical resistance, the transmittance, the haze, and so on, are all similar. As for the resistance, due to the high aspect ratio of the metal nanowire, where the slot die coating is used, the shear force between the machine nozzle and the substrate causes most of the metal nanowire to be arranged along the machine direction (transmission direction of the substrate, i.e., MD direction), so the resistance along the machine direction would be smaller than other directions. By contrast, the horizontal axis direction perpendicular to the machine direction (i.e., TD direction) has a relatively large resistance. In other words, without other adjustments, the metal nanowire layer formed by the slot die coating has obvious anisotropy. For example, the ratio of the resistance in the horizontal axis direction (R_{TD}) to the resistance in the machine direction (R_{MD}) is greater than 2. Basically, the metal nanowire in the ink layer formed by the spraying process in this embodiment is arranged randomly, so the properties of each direction are similar. Compared with the aforementioned R_{TD}/R_{MD} (because a spraying process does not have TD and MD directions), in this embodiment, the resistances of the sprayed ink layer in two directions (two orthogonal directions) were measured, and the resistance ratio of the two directions was 0.97±0.09, which shows that the spraying process of this embodiment has high isotropy.

In summary, the sprayable conductive ink provided by the present disclosure can be sprayed on generally flat substrates, uneven surface substrates, and curved substrate surfaces, such as curved glasses. The obtained transparent conductive glass has good appearances and chemical properties at the same time. The obtained transparent conductive glass is uniform, has a smooth surface (i.e., defect-less surface), and has the properties of high transmittance and low haze. Because the ink layer includes the metal nanowire, the obtained transparent conductive glass has a conductive surface. In addition, because the obtained transparent conductive glass has good appearance without the problems of bubbles, pinholes, and so on, the transparent conductive glass has the advantages of uniform heating and fast heating rate. The sprayable conductive ink of the present disclosure can be applied to various non-planar substrates, such as automotive windshields.

Table 2 shows the heating rate experiment of the conductive film formed by the sprayable conductive ink of the present disclosure after energization. In this embodiment, an oil film with a resistance of 18.6 Ohm/square was formed on a glass substrate having a surface area of 0.34×0.47 m² to form a conductive device, and the glass substrate was connected to an external power source that provided a predetermined power density so that the conductive device rose by more than 20° C. in a predetermined period. It can be concluded from Table 2 that, when the predetermined energy density provided by the power source is above 900 W/m², the temperature of the conductive device increases by more than 20° C. within 5 minutes (the heating rate was about 4° C./min). When the predetermined energy density provided by the power source is about 700 W/m², the temperature of the conductive device can increase by more than 20° C. within 10 minutes (according to the continuous energization experiment of this embodiment, the temperature rose to 20° C. in about 7 minutes, and the heating rate is about 3° C./min). When the predetermined energy density provided by the power source is about 500, the temperature of the conductive device can increase by more than 20° C. in about 15 minutes (the heating rate is about 1.33° C./min). As mentioned above, the heating effect of the conductive film of this embodiment after energization has the function of defogging and/or defrosting windows. It is worth noting that the above heating rate was a simple calculation of temperature versus time, and the actual heating curve can be linear or non-linear. In one embodiment, multiple locations (for example, four points) of the sprayed sample are selected for energization and the heating experiment. It was found that, under the same voltage supply, the heating curves of the multiple locations (the curves of heating time versus film temperature) almost overlapped completely, which indicates that the conductive film of this embodiment has good and uniform heating performance. In this embodiment, under the same voltage supply, the temperature variations between any two positions on the conductive film of this embodiment are below 10%, below 5%, below 2%, below 1%, or below 0.5%.

In another embodiment, the heating effect of the conductive film of this embodiment after energization can also be applied to displays, such as a car display. The car display has the problems of display delay (i.e., not a real-time display frame) and incorrect color display at low temperatures, and so, in cold zone countries/environments, the car display may be temporarily unavailable when the vehicle is started. However, the conductive film of this embodiment can be assembled in the display. Thus, when the vehicle is started, the power source on the vehicle can apply voltage and current to the conductive film of this embodiment, so that the conductive film provides a rapid heating effect and solves the aforementioned display problems.

In one embodiment, because the sprayed ink layer of this embodiment has high isotropy, the uniformity of the temperature performance of the ink layer is also quite good during the heating process, so there is a consistent effect for the entire device (for example, the car window defogging).

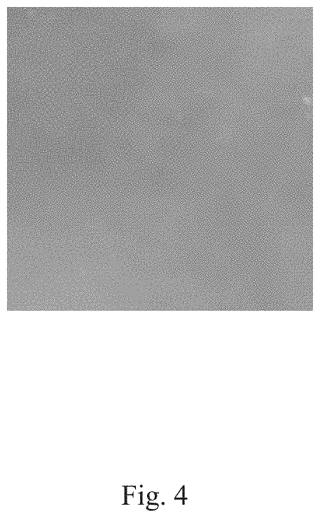

In one embodiment, the ink includes the following composition: 0.05 to 1 part by weight of the metal nanowire, 0.1 to 1 part by weight of the resin, 97.9 to 99.5 parts by weight of the solvent, and 0.02 to 0.1 parts by weight of the additive. The composition can be used in the following spraying processes: the spraying flow (g/mm): 1-5, the spraying speed (m/sec): 400-500, and atomization pressure (psi): 1-3, to form the conductive film with the high transmittance, the low haze and the good appearance, as shown in FIG. 4, in which the coated ink layer is a smooth and defect-less surface under strong light. The formed conductive film has the advantages of uniform heating and fast heating rate.

While the disclosure has been described by way of example(s) and in terms of the preferred embodiment(s), it is to be understood that the disclosure is not limited thereto. On the contrary, it is intended to cover various modifications and similar arrangements and procedures, and the scope of the appended claims for any person skilled in this art, therefore, the scope of protection of this disclosure shall be subject to the scope of the attached patent application and its equivalent plan.

What is claimed is:

1. A sprayable conductive ink, comprising:
0.05 to 1 part by weight of a metal nanowire;
0.1 to 1 part by weight of a resin;
97.9 to 99.5 parts by weight of a solvent; and
0.02 to 0.1 parts by weight of an additive, wherein the sprayable conductive ink is used for spraying on a substrate.

2. The sprayable conductive ink of claim 1, wherein the sprayable conductive ink has a viscosity between 0.5 cP and 50 cP.

3. The sprayable conductive ink of claim 1, wherein the sprayable conductive ink has a surface tension between 10 mN/m and 50 mN/m.

4. The sprayable conductive ink of claim 1, wherein a material of the metal nanowire is copper, gold, silver, nickel, iron, tin, or palladium.

5. The sprayable conductive ink of claim 1, wherein the resin is polyvinyl butyral resin, ethyl cellulose, polyethylene, polystyrene, polytetrafluoroethylene, phenolic resin, polyamide resin, polypropylene, polycarbonate, hydroxypropyl methylcellulose, methylcellulose, carboxymethyl cellulose, or organosilicon.

6. The sprayable conductive ink of claim 1, wherein the additive is selected from the group consisting of octylphenol ethoxylate, nonylphenol ethoxylate alkylphenol, fluorinated surfactant, modified polysiloxane, and a copolymer of organosilicon and glycol.

7. The sprayable conductive ink of claim 1, wherein the additive comprises a surfactant, a dispersant, a surface adjuster, a defoaming agent, or a combination thereof.

8. The sprayable conductive ink of claim 7, wherein the sprayable conductive ink comprises 0.001 to 0.01 parts by weight of the surfactant.

9. The sprayable conductive ink of claim 7, wherein the sprayable conductive ink comprises 0.01 to 0.1 parts by weight of the dispersant.

10. The sprayable conductive ink of claim 7, wherein the sprayable conductive ink comprises 0.01 to 0.1 parts by weight of the surface adjuster.

11. The sprayable conductive ink of claim 7, wherein the sprayable conductive ink comprises 0.02 to 0.1 parts by weight of the defoaming agent.

12. A conductive device, comprising:
a substrate; and
an ink layer covering on the substrate, wherein the ink layer is formed by spraying the sprayable conductive ink of claim 1, a resistance of the ink layer is between 18 and 22 Ohm/square, a transmittance of the ink layer is greater than 90%, and a haze of the ink layer is less than 1.8%.

13. The conductive device of claim 12, wherein the ink layer is connected to an external power source to heat the conductive device.

14. The conductive device of claim 13, wherein the external power source provides a predetermined power density so that the conductive device rises by more than 20° C. in a predetermined period.

15. The conductive device of claim 12, wherein the ink layer has a smooth surface under a strong light.

16. The conductive device of claim 12, wherein a resistance ratio of the ink layer is 0.97±0.09 in two orthogonal directions.

17. The conductive device of claim 12, wherein the substrate is a curved substrate.
